(19) United States
(12) Patent Application Publication
(10) Pub. No.: US 2005/0181787 A1
(43) Pub. Date: Aug. 18, 2005

(54) Systems and methods for encoding and decoding data messages

(76) Inventors: Tom D. Judd, Woodinville, WA (US); Willard R. True, Kirkland, WA (US); Mark E. Henninger, Glendale, AZ (US); Bryan L. Rowe, Phoenix, AZ (US); Therin L. Dastrup, Scottsdale, AZ (US); Cory M. Berg, Mesa, AZ (US)

Correspondence Address: BLACK LOWE & GRAHAM, PLLC, 701 FIFTH AVENUE, SUITE 4800, SEATTLE, WA, 98104, US

(21) Appl. No.: 10/782,519

(22) Filed: Feb. 18, 2004

(51) Int. Cl. H04L 12/66; H04Q 7/20; H04M 11/00

(52) U.S. Cl. 455/431; 455/403

(57) ABSTRACT

A system and method for allowing changes to Abstract Syntax Notation One (ASN.1) defined messages without initiating regulatory requirements. The system receives a message formatted according to ASN.1 compatible encoding rules, such as Basic Encoding Rules (BER) or Packed Encoding Rules (PER) and decodes the received message based on a previously stored configuration information file (CIF). In addition, the system encodes ASN.1 defined messages, which are to be sent, using ASN.1 compatible encoding rules based on the information stored in the CIF. The messages are transmitted and received according to a datalink protocol, such as the Aircraft Communications Addressing and Reporting System (ACARS) protocol or the Aeronautical Telecommunications Network (ATN) protocol. In addition, the CIF also defines processing (beyond encoding/decoding) associated with the message.

### FIELD OF THE INVENTION

This invention relates generally to data messages and, more specifically, to ASN.1 defined messaging systems and methods.

### BACKGROUND OF THE INVENTION

Air Traffic Service (ATS) application messages and Airline Operations Control (AOC) application messages provide data communication between ground facilities and aircraft. In order to make additions, modifications, etc. to messages, the corresponding avionics application software on the aircraft would need to be updated. Avionics application software has significant costs associated with developing and maintaining software due to stringent procedures called out in the Requirements and Technical Concepts for Aviation (RTCA) D0-178B Software Considerations in Airborne Systems and Equipment Certification standard. Avionics application software upgrades require changes to documentation, changes to code, and changes to testing, etc. Changes require inspections, regression analysis, etc. In addition, there are significant costs to certifying an upgrade to the operational software for an avionics unit.

Abstract Syntax Notation One (ASN.1) (ISO/IEC 8824 and 8825) is a standard language used to define data communications messages that include the application messages. ASN.1 defines the semantics of the message. In order to be communicated via a data communications service (e.g., sending a message from one station to another, like e-mail), the messages are encoded and then decoded on the receiving side using encoding/decoding rules. Standard encoding rules associated with ASN.1 defined messages include Basic Encoding Rules (BER) and Packed Encoding Rules (PER).

The traditional approach to implementing encoder/decoders for ASN.1 defined messages is shown in FIG. 1. For this traditional approach, ASN.1 defined messages are fed through an ASN.1 compiler to obtain compilable or linkable entities (e.g., C source file structures and modules, object files, etc.). The entities are compiled and linked with the other operational software components to obtain resultant software executable, which includes the ability to decode and encode messages that were defined in the original ASN.1 message schema.

If one desires to make any changes to the messages, the operational software that receives the compiled message must be changed because the ASN.1 defined messages are compiled. In certain industries (e.g., aviation), when operational software is changed, an expensive recertification process must occur.

Therefore, there exists a need to allow updating of ASN.1 defined messages without initiating regulatory requirements.

### SUMMARY OF THE INVENTION

The present invention is a system and method for allowing changes to Abstract Syntax Notation One (ASN.1) defined messages without initiating regulatory requirements.

An exemplary method receives a message formatted according to ASN.1 and decodes the received message based on a previously stored configuration information file (CIF). Also, an exemplary method sends an ASN.1 defined message per ASN.1 compatible encoding rules based on information stored in the CIF.

In one aspect of the invention, the received message is encoded according to a ASN.1 compatible encoding rule such as Basic Encoding Rules (BER) or Packed Encoding Rules (PER).

In another aspect of the invention, the CIF includes schema of the ASN.1 formatted message and definitions of actions for creating new messages without updating associated operational software.

In a further aspect of the invention, transmission and reception are performed according to a datalink protocol, such as the Aircraft Communications Addressing and Reporting System (ACARS) protocol, the Aeronautical Telecommunications Network (ATN) protocol, the Transmission Control Protocol/Internet Protocol (TCP/IP) or another network protocol.

### BRIEF DESCRIPTION OF THE DRAWINGS

The preferred and alternative embodiments of the present invention are described in detail below with reference to the following drawings.

FIG. 1 is a flow diagram of message transmission according to the prior art;

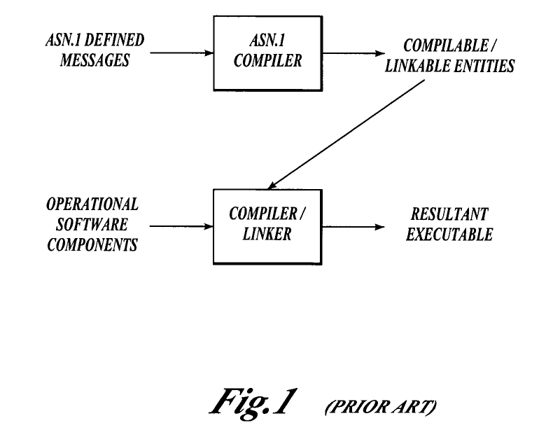

FIG. 2 is a block diagram of an example system formed in accordance with the present invention;

FIG. 3 is a flow diagram of an example process performed by the system shown in FIG. 2;

FIG. 4 is a block diagram of an example encoder/decoder formed in accordance with the present invention; and

FIG. 5 is an example of an encoded message transmitted and received by the system shown in FIG. 2.

### DETAILED DESCRIPTION OF THE PREFERRED EMBODIMENT

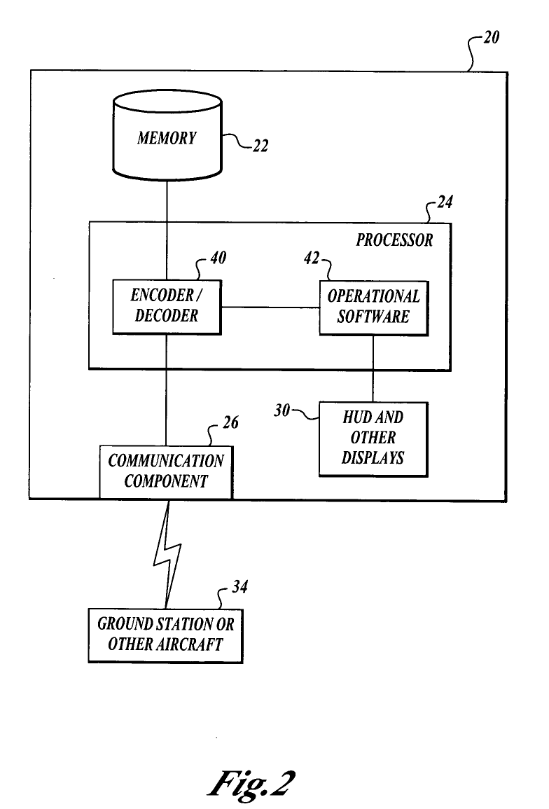

FIG. 2 shows one embodiment of an example system 20 for allowing one to change Abstract Syntax Notation One (ASN.1) defined messages without making changes to the associated application (operational software, such as the controller pilot data link communication (CPDLC) application implemented in an aircraft Communications Management Unit or Flight Management Computer (FMC)). The system 20 includes memory 22, a processor 24, a communication component 26, and one or more displays 30 (such as Heads-Up Display (HUD) or Multi-Function Displays (MFD) or Multifunction Control Display Unit (MCDU)). The system 20 is used in an aircraft for sending and receiving data messages via an aviation protocol such as the Aircraft Communications Addressing and Reporting System (ACARS) and the Aeronautical Telecommunications Network (ATN) or some other air/ground subnetwork.

The system 20 sends and receives ASN.1 encoded messages to and from a remote facility 34 via the communication component 26. The processor 24 includes an encoder/decoder 40 and an operational software component 42 encodes messages to be sent to the remote facility 34 and decodes received ASN.1 encoded messages. The operational software component 42 executes operational software stored in the memory 22 based on information included in the decoded message. The executed application program generates messages that are encoded by the encoder/decoder 40 for transmission to the remote facility 34.

The memory 22 also includes a previously defined Configuration Information File (CIF). The CIF includes the schema of the ASN.1 encoded messages. The CIF defines actions for allowing creation of new messages without having to update the operational software. The CIF is generated by a CIF Generation Tool, such as the Communications Management Unit Ground Based Software Tool (CMU GBST). The CIF is then stored in the memory 22 before operational use of a complex system (e.g., aircraft) where the system 20 is implemented.

Currently, communications between the system 20 and the remote facility 34 utilize an aeronautical datalink protocol such as ACARS and ATN. ACARS is the traditional aeronautical datalink protocol, which is a character-oriented protocol. Applicable ACARS standards are ARINC 618, 619, 620, 622, and 623. ATN is the next generation aeronautical datalink protocol, which is bit oriented based on the Open Systems Interconnection (OSI) Model. The applicable ATN standard is DOC 9705-AN/956 Manual of Technical Provisions for the ATN. Future options for communications between the system 20 and the remote facility 34 may use other internet protocols such as the Transmission Control Protocol/Internet Protocol (TCP/IP) as defined in Internet STD0001 (currently Internet Engineering Task Force RFC 3600).

The system 20 is utilized for the following example types of communications:
1. Airline Operations Control (AOC) includes communications between flight crew (pilot/co-pilot) and/or cabin crew (stewards/stewardesses) on the airplane with airline operations on the ground. Example datalink communications include gate information, requests for wheelchairs, etc.
2. Air Traffic Services (ATS) is used for communications with the Air Traffic Control (ATC). ATS includes datalink communications such as clearances (e.g. permission to climb to 30,000 feet).

(ATS) application messages are defined using ASN.1 and the messages are encoded using Packed Encoding Rules (PER). Examples include:
1. Context Management (CM)—Used for ATN [and] ATS applications to log onto the ATC Center from the airplane.
2. Automatic Dependent Surveillance (ADS)—Used to report position information and other surveillance related data from the airplane to the ground.
3. Controller/Pilot Datalink Communication (CPDLC)—Used for communications between the flight crew and the ATC.
   Uplink Messages

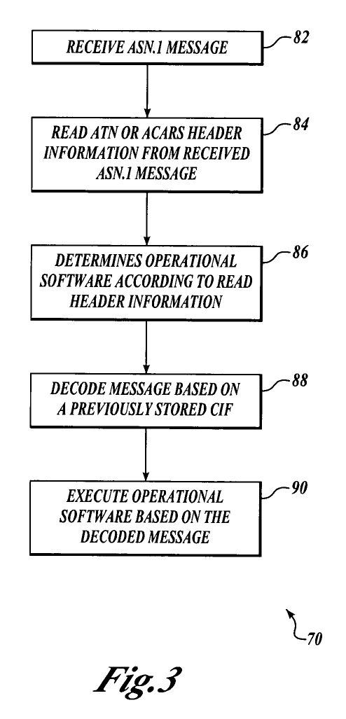

FIG. 3 illustrates an example process 70 performed by the system 20. At block 82, an ASN.1 message is received by the system 20. At block 84, the processor 24 reads header information of the received ASN.1 message. The processor 24 determines the operational software associated with the read header information, see block 86. At block 88, the encoder/decoder 40 decodes the ASN.1 message based on a previously stored CIF. At block 90, the determined operational software is executed based on the decoded ASN.1 message.

The CIF defines uplink message definition based on the ASN.1 schema. The CIF is tree-based and table driven to define message syntax. The CIF also defines what actions are to be taken or can be taken with the message (e.g. display including format, print including format, responses, pilot actions, etc.). The CIF can be updated as messages evolve.

The uplink processing software is DO-178B certified once to decode and process the uplink messages using PER based on the message schema provided within the CIF. Certain messages in the future may be defined as some other ASN.1 compatible encoding rule such as BER encoded. The uplink message would be decoded for processing (e.g., display, printing, automatic actions, crew actions, etc.) based on the CIF definition. If the definition of the uplink message changed, the CIF would be updated, but the operational software would not have to be changed.

Downlink Messages

The CIF defines message schema for a downlink message. The CIF may also define:
a) how the message is created (e.g., an element of the message may be hard-coded, or user-entered, or based on current value of a piece of data); and
b) the display definition (e.g., layout of a downlink message display page including any actions that can be taken).

The downlink processing software is DO-178B certified one time to encode and process the downlink messages using the PER based on the message schema within the CIF. Certain messages may be defined using some other ASN.1 compatible encoding rule such as as Basic Encoding Rules (BER) encoded. If the schema of the downlink message changed, the CIF would be updated, but the operational software would not be changed.

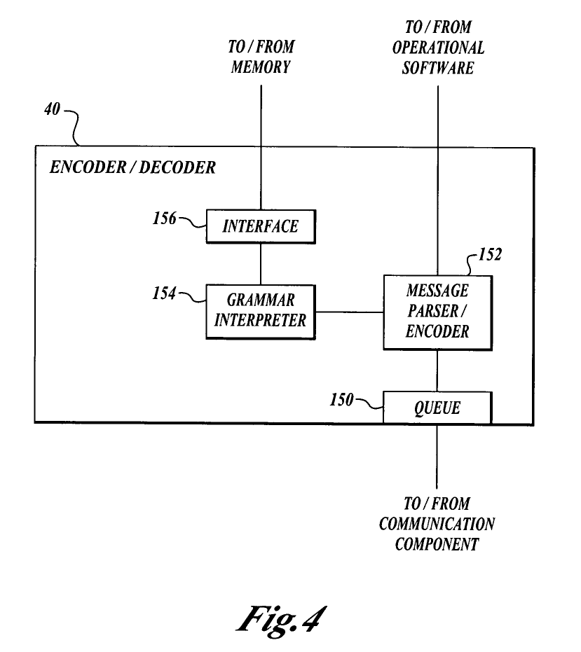

FIG. 4 illustrates components of the encoder/decoder 40. The encoder/decoder 40 includes a queue 150, a message parser/encoder 152, a grammar interpreter 154, and a CIF interface 156. The queue 150 sends and receives messages from the communication component 26. The message parser/encoder 152 is coupled to the queue 150 and the grammar interpreter 154 and sends information to and receives information from the operational software 42. The grammar interpreter 154 sends/receives information to/from the memory 22 via the CIF interface 156.

Decoding

The communication component 26 places a message addressed to the system 20 in the queue 150. The message parser/encoder 152 extracts the message from the queue 150 and uses the subroutines in the grammar interpreter 154 to construct a parsed representation of the message. To perform this step, the routines of the grammar interpreter 154 access the stored CIF via interface 156 to determine the syntax with which the message should be interpreted. The grammar interpreter 154 also retrieves the action to be performed from the CIF via interface 156. After the message is parsed, the content (data values) from the message and associated action(s) are sent by the message parser/encoder 152 to the operational software using an appropriate application specific format.

Encoding

A downlink message is initiated by the operational software. The downlink may be triggered automatically (for example at a given time or when the aircraft reaches a particular location); may be initiated by the flight crew; or may be generated by the system in response to an uplink message. The operational software invokes the message parser/encoder 152 to generate the downlink message. The message parser/encoder uses the grammar interpreter 154 to format the message according to the representation stored in the memory 22. The CIF may indicate that some portion of the message may require aircraft data (for example altitude or airspeed) or may need a pilot entry (for example a request to deviate from the current flight plan) or may require a hard coded value (for example aircraft tail number). The message parser/encoder 152 obtains any data that is not resident in the encoder/decoder 40 or memory 22 from the operational software. The message parser/encoder 152 then encodes the message in either the BER or PER as indicated in the CIF definition for the given the message. The message parser/encoder 152 then places the encoded message in the queue 150 to be delivered by the communication component 26 to the ground station or other aircraft using a datalink protocol.

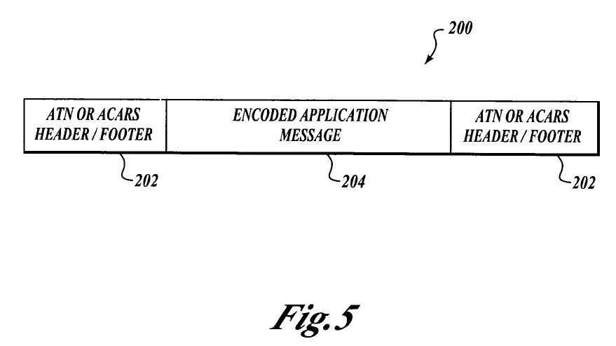

FIG. 5 illustrates an example frame of transmitted data 200. The frame 200 includes an encoded application message 202 surrounded by transmission protocol (ATN or ACARS) header and footer information 204.

Another aspect to the CIF includes a definition of what to do with (i.e., how to process) the message (downlink or uplink). For example, processing of the message may include: how the message and data are displayed; what pilot actions are required or optional (e.g., enter data); loading data into other systems (e.g., loading flight plan data into the FMC); etc. Each message (in addition to encoding or decoding information) also defines what is to be done with the message and that information is also included in the CIF and the operational software interprets this CIF information.

While the preferred embodiment of the invention has been illustrated and described, as noted above, many changes can be made without departing from the spirit and scope of the invention. For example, the above described approach is intended for airplane avionics, but could be used for other types of systems in other industries. Accordingly, the scope of the invention is not limited by the disclosure of the preferred embodiment. Instead, the invention should be determined entirely by reference to the claims that follow.

1. A method comprising:
a. receiving a message formatted according to Abstract Syntax Notation One (ASN.1); and
b. decoding the received message based on a previously stored configuration information file (CIF).

2. The method of claim 1, wherein the received message is formatted according to an ASN.1 compatible encoding rule.

3. The method of claim 1, wherein the CIF includes schema of the ASN.1 formatted message.

4. The method of claim 3, wherein the CIF further includes a means for defining new messages without updating associated operational software.

5. The method of claim 1, further comprising:
c. encoding a message formatted according to ASN.1, wherein encoding is based on the CIF; and
d. transmitting the encoded message.

6. The method of claim 5, wherein encoding the message is performed according to an ASN.1 compatible encoding rule.

7. The method of claim 5, wherein a-d are performed on an aircraft.

8. The method of claim 7, wherein transmitting and receiving are performed according to a datalink protocol.

9. The method of claim 8, wherein the datalink protocol includes an aeronautical datalink protocol.

10. A system comprising:
a means for receiving a message formatted according to Abstract Syntax Notation One (ASN.1);
a memory for storing and accessing a configuration information file (CIF); and
a means for decoding the received message based on the stored CIF.

11. The system of claim 10, wherein the received message is formatted according to an ASN.1 compatible encoding rule.

12. The system of claim 10, wherein the CIF includes schema of the ASN.1 formatted message.

13. The system of claim 12, wherein the CIF further includes a means for defining processing of a message without updating associated operational software.

14. The system of claim 10, further comprising:
a means for encoding a message formatted according to ASN.1, wherein encoding is based on the CIF; and
a means for transmitting the encoded message.

15. The system of claim 14, wherein the means for encoding encodes the message according to an ASN.1 compatible encoding rule.

16. The system of claim 14, wherein the system is located on an aircraft.

17. The system of claim 16, wherein transmitting and receiving are performed according to a datalink protocol.

18. The system of claim 17, wherein the datalink protocol includes an aeronautical datalink protocol.

19. A system comprising:
a receiver configured to receive a message formatted according to Abstract Syntax Notation One (ASN.1) using an ASN.1 compatible encoding rules;
a memory configured to store a configuration information file (CIF); and
a processor coupled to the receiver and the memory, the processor being configured to decode the received message based on the stored CIF.

20. The system of claim 19, wherein the ASN.1 compatible encoding rule includes at least one of Basic Encoding Rules (BER) or Packed Encoding Rules (PER).

21. The system of claim 19, wherein the CIF includes schema of the ASN.1 formatted message.

22. The system of claim 21, wherein the CIF further includes a means for defining processing of a message without updating associated operational software.

23. The system of claim 19, wherein the processor comprises a component configured to encode a message formatted according to ASN.1 based on the CIF.

24. The system of claim 23, further comprising a transmitter configured to transmit the encoded message.

25. The system of claim 23, wherein the component configured to encode encodes the message according to an ASN.1 compatible encoding rule.

26. The system of claim 19, wherein the system is located on an aircraft.

27. The system of claim 26, wherein the receiver and transmitter perform data reception and transmission according to a datalink protocol.

28. The system of claim 27, wherein the datalink protocol includes an aeronautical datalink protocol.

29. The system of claim 27, wherein the datalink protocol includes the Transmission Control Protocol/Internet Protocol (TCP/IP).

30. A method comprising:
a. encoding a message formatted according to ASN.1, wherein encoding is based on a previously stored configuration information file (CIF); and
b. transmitting the encoded message.

31. The method of claim 30, wherein encoding the message is performed according to an ASN.1 compatible encoding rule.

32. The method of claim 30, wherein a and b are performed on an aircraft.

33. The method of claim 32, wherein transmitting and receiving are performed according to a datalink protocol.

34. The method of claim 33, wherein the datalink protocol includes an aeronautical datalink protocol.

35. A system comprising:
a means for encoding a message formatted according to ASN.1, wherein encoding is based on a previously stored configuration information file (CIF); and
a means for transmitting the encoded message.

36. The system of claim 35, wherein the means for encoding encodes the message according to an ASN.1 compatible encoding rule.

37. The system of claim 35, wherein the system is located on an aircraft.

38. The system of claim 37, wherein transmitting and receiving are performed according to a datalink protocol.

39. The system of claim 38, wherein the datalink protocol includes an aeronautical datalink protocol.
